(19) United States
(12) Patent Application Publication
(10) Pub. No.: US 2025/0313464 A1
(43) Pub. Date: Oct. 9, 2025

(54) METHOD OF HIGH EFFICIENCY ELECTRICAL HEATING FOR A THERMOCHEMICAL PROCESS

(71) Applicant: OMC Hydrogen, Inc., Louisville, CO (US)

(72) Inventors: Kent Warren, Broomfield, CO (US); Juan Inga, Fort Worth, TX (US); Britt Boughey, Ventura, CA (US); Patrick Vincent, Erie, CO (US)

(73) Assignee: OMC Hydrogen, Inc., Louisville, CO (US)

(21) Appl. No.: 19/174,630

(22) Filed: Apr. 9, 2025

Related U.S. Application Data
(60) Provisional application No. 63/631,822, filed on Apr. 9, 2024.

(51) Int. Cl. C01B 3/44; C01B 3/04

(52) U.S. Cl. CPC C01B 3/44; C01B 3/042; C01B 2203/0261; C01B 2203/0283; C01B 2203/085; C01B 2203/0855; C01B 2203/0883; C01B 2203/1258

(57) ABSTRACT

Various aspects of this disclosure relate to large-scale commercial systems and methods of thermochemical processes to produce green hydrogen or syngas from one or more of a hydrocarbon, H₂O, and CO₂ via a thermochemical gas splitting reactor system. In some embodiments, the systems and methods include a standalone thermochemical reactor that bypasses the requirement for direct concentrated solar radiation as the source of process heat. In some embodiments, the systems and methods include a well-insulated, refractory-lined steel pressure vessel, in which process gases heated indirectly via radiation can be delivered to facilitate the desired thermochemical reactions in a fluidized bed configuration.

### CROSS-REFERENCE TO RELATED APPLICATIONS

This patent application claims priority of U.S. Provisional Patent Application No. 63/631,822, entitled “METHOD OF HIGH EFFICIENCY ELECTRICAL HEATING FOR A THERMOCHEMICAL PROCESS,” filed Apr. 9, 2024, which is hereby incorporated by reference in its entirety.

### BACKGROUND OF CERTAIN ASPECTS OF THE DISCLOSURE

Green hydrogen has massive potential to decarbonize many industries such as conventional and renewable fuel refining, chemical production, fertilizer, steelmaking, and more. Syngas is a precursor to many important chemicals and fuels. Current hydrogen and syngas production technologies are fossil fuel based, highly polluting, subject to extreme price volatility, or inefficient and economically impractical.

Most hydrogen is produced from steam reforming of natural gas, emitting ten or more tons of CO₂ for each ton of H₂ produced. Clean alternatives are hampered by dependence on ubiquitous, low-cost substantially renewable electricity to emerge, scaling challenges, reliability, durability, and selectivity issues, and dependence on scarce materials and overseas manufacturing. For example, direct solar has been used to produce syngas but direct solar has been unable to meet the demands of industry for syngas production. Specifically, locations that receive enough sunlight to be considered reliable sources of direct solar do not generally also include large industrial facilities that require syngas or hydrogen for use with other processes. Furthermore, the unreliability of direct solar due to cloud cover or the setting of the sun makes direct solar unsuitable for continuous manufacturing processes.

Additionally, at least some known processes for adding substantially renewable energy/heat to reactors used to produce hydrogen or syngas have used resistive heating elements within the fluidized bed to heat the reactors. Commercially available resistive heating element variants, despite being a more conventional approach to supplying electrical heat, are not able to tolerate both reducing and oxidizing atmospheres. Additionally, resistive heating elements are positioned within the reactor and disrupt the flow of process gases within the fluidized bed region of the reactor system, making them unsuitable for the production of green hydrogen and syngas. As a result, for thermochemical gas splitting technologies, such heating elements would need to be shielded, either via an environmental barrier coating or via insertion into a ceramic tube, both of which introduce additional design complexity at large scales.

Alternative approaches for producing syngas remain uncompetitive with fossil fuels due to the same challenges faced by green hydrogen production along with the additional challenges of requiring multiple reactors and reaction steps, such as technologies that rely on combining water electrolysis with reverse water-gas shift, or face selectivity and catalyst consumption challenges.

It is desirable to safely and affordably produce low-emissions hydrogen or syngas commercially, in large scale operations, and to use electrical heating for the reactor system (versus the solar receiver technology previously demonstrated).

### BRIEF SUMMARY OF SOME ASPECTS OF THE DISCLOSURE

The present disclosure relates to large-scale commercial systems and methods of thermochemical processes to produce green hydrogen or green syngas from one or more of H₂O and CO₂ via a thermochemical gas splitting reactor system.

In some embodiments, the systems and methods include a standalone thermochemical reactor that bypasses the requirement for direct concentrated solar radiation as the source of process heat.

In some embodiments, the systems and methods include a well-insulated, refractory-lined steel pressure vessel, in which process gases heated indirectly via concentrated solar radiation can be delivered to facilitate the desired thermochemical reactions in a fluidized bed configuration.

In some embodiments, the systems and methods include other sustainable sources of heat, including heat derived from electricity (e.g., substantially renewable) via electromagnetic induction.

In some embodiments, the systems and methods described herein include a method of producing hydrogen or syngas by thermochemical splitting of water, carbon dioxide, and/or hydrocarbons. The method includes pre-heating one or more gases. The method also includes injecting the one or more gases including the water (steam), the carbon dioxide, and/or the hydrocarbons into a gas inlet in a reactor system. The method further includes providing process heat via susceptor radiation. The method also includes fluidizing particles via the one or more gases in a fluidized bed region. The method further includes dissociating the water and/or the carbon dioxide or partially oxidizing the hydrocarbons. The method also includes moving the one or more gases through an upper plenum. The method further includes exiting the one or more gases from the upper plenum through a gas outlet.

In some embodiments, the systems and methods described herein include a thermochemical gas splitting reactor system. The thermochemical gas splitting reactor system includes a reactor lined with refractory brick. The reactor includes a gas inlet to receive one or more pre-heated gases, a fluidized bed region for receiving process heat and fluidizing particles via the one or more gases, an induction coil embedded in the refractory brick coupled to a susceptor to conduct radiative heat to the fluidized bed region to dissociate water and carbon dioxide or partially oxidize a hydrocarbon to produce hydrogen and/or carbon monoxide, an upper plenum to receive the one or more pre-heated gases, and a gas outlet.

### BRIEF DESCRIPTION OF THE DRAWINGS

The preferred and other embodiments are disclosed in association with the accompanying drawings in which:

FIG. 1 is a schematic drawing of an embodiment of a reactor system for green hydrogen, low-carbon hydrogen, green syngas or low-carbon syngas production via thermochemical gas splitting in accordance with aspects of the present disclosure.

FIG. 2 is a schematic drawing of an embodiment of a reactor system for green hydrogen, low-carbon hydrogen, green syngas or low-carbon syngas production via thermochemical gas splitting in accordance with aspects of the present disclosure.

FIG. 3 is a flow diagram of an embodiment of a continuous configuration process for a reactor system in accordance with aspects of the present disclosure.

FIG. 4 is a flow diagram of an embodiment of another continuous configuration process for a reactor system in accordance with aspects of the present disclosure.

FIG. 5 is a flowchart of example operations for a method of producing hydrogen or syngas via a thermochemical gas splitting reactor system.

### DETAILED DESCRIPTION

In the following description, for the purposes of explanation, numerous specific details are set forth to provide a thorough understanding of the present invention. It will be apparent, however, to one skilled in the art that the present invention may be practiced without some of these specific details. For example, while various features are ascribed to particular implementations, it should be appreciated that the features described with respect to one implementation may be incorporated with some other implementations as well. Similarly, however, no single feature or features of any described implementation should be considered essential to the invention as some implementations of the invention may omit such features.

The systems and methods described herein include thermochemical systems that produce green hydrogen, low-carbon hydrogen, green syngas, or low-carbon syngas using substantially renewable energy sources. Substantially renewable energy sources refer to energy sources in which heat is not exclusively generated from renewable energy. Specifically, the systems and methods described herein include reactors that include induction heating elements capable of heating process gases within the reactor using substantially renewable energy sources. The induction heating elements are capable of heating material within a fluidized bed region of the reactor without disrupting the flow of process gases within the fluidized bed region and within the short residence time of the process gases within the fluidized bed region. As such, the induction heating elements are capable of producing green hydrogen, low-carbon hydrogen, green syngas, or low-carbon syngas using substantially renewable energy sources. Also, inductive heating allows for the use of susceptors (e.g., silicon carbide, boron carbide, etc.) that are readily scalable, are stable under both atmospheres, and can efficiently radiate heat to the reacting media.

In the illustrated embodiments, substantially renewable sources of heat are used to drive a thermochemical reaction within the reactor, which produces separate streams of oxygen and either green hydrogen, low-carbon hydrogen, green syngas, or low-carbon syngas, depending on the inputs into the reactor system. The resultant green hydrogen, low-carbon hydrogen, green syngas, or low-carbon syngas can then be used in various processes.

As used herein, syngas includes a gaseous mixture of carbon monoxide (CO) and hydrogen (H₂). Syngas has commercial uses being converted into higher value hydrocarbons such as methanol, jet and diesel fuels, gasoline, waxes, lubricants, and can even be fermented into alcohols. However, syngas is almost exclusively derived from coal or natural gas. Hydrogen is widely used throughout major industries such as petroleum and biofuels refining and ammonia production. When produced cleanly, hydrogen helps decarbonize these existing industries as well as potential emerging uses such as transportation and steelmaking.

Current commercially available resistive heating element variants, despite being a more conventional approach to supplying electrical heat, are not able to tolerate both reducing and oxidizing atmospheres and disrupt the flow of process fluid within the reactors. As such, resistive heating elements are unsuitable for thermochemical gas splitting technologies. Additionally, until relatively recently, ubiquitous, low-cost, reliable, and substantially renewable electricity was unavailable for continuous manufacturing processes. For example, direct solar sources of renewable energy could not be used at night for continuous manufacturing processes.

The systems and methods described herein include induction heating elements that are capable of heating material within a fluidized bed region of the reactor without disrupting the flow of process gases within the fluidized bed region. When used in combination with a reliable source of substantially renewable energy, the systems and methods described herein are capable of producing substantially green or renewable hydrogen or syngas, reducing the environmental impact of syngas and substantially reducing costs. The disclosed technology relates to systems and methods of thermochemical processes to produce green hydrogen or green syngas from one or more of hydrocarbons (CH₄ or higher), water, and/or carbon dioxide (CO₂) via a thermochemical gas splitting reactor system. The systems and methods include a standalone thermochemical reactor that bypasses the requirement for direct concentrated solar radiation as the source of process heat. The systems and methods may be used for large-scale commercial systems.

More specifically, the disclosed technology is used in various configurations to produce green hydrogen, low-carbon hydrogen, green syngas, or low-carbon syngas. For example, a first configuration or the green hydrogen configuration is configured to produce green hydrogen, a second configuration or the low-carbon hydrogen configuration is configured to produce low-carbon hydrogen, a third configuration or the green syngas configuration is configured to produce green syngas, and a fourth configuration or the low-carbon syngas configuration is configured to produce low-carbon syngas. For purposes of this disclosure, the terms “hydrogen or syngas” or “hydrogen/syngas” used with systems and components in the example configurations correspond to embodiments producing green hydrogen, low-carbon hydrogen, green syngas, or low-carbon syngas. The term “water/carbon dioxide” used with systems and components in the example configurations corresponds to embodiments producing green hydrogen, low-carbon hydrogen, green syngas, or low-carbon syngas, as applicable.

In some embodiments, the configurations each include two reactors: an oxidation reactor and a reduction reactor. In each configuration the oxidation reactor is fed with water, and the oxidation reactor splits the water into hydrogen (H₂) and oxygen (O₂). In the green and low-carbon syngas configurations the oxidation reactor is also fed with carbon dioxide (CO₂), and the oxidation reactor also produces carbon monoxide (CO) in addition to hydrogen and oxygen. The oxidation reactions in the oxidation reactor all occur in the presence of a metal oxide powder (MOP) that may act as a catalyst for the reactions in some configurations. In some configurations the metal oxide powder does not catalyze a reaction but is configured to abstract oxygen from an oxidant and transport the oxidized material from the oxidation reactor to the reduction reactor for further processing. In all configurations the metal oxide powder is configured to abstract the oxygen from the delivered oxidants and transport the oxygen from the oxidation reactor to the reduction reactor for further processing.

In each of the configurations, the reduction reactor includes induction heating elements configured to heat the fluidized bed region of the reduction reactor to liberate the oxygen from the metal oxide powder such that the metal oxide powder is recycled to be used in the oxidation reactor. Specifically, in the green hydrogen and green syngas configurations, the reduction reactor is fed with oxidized metal oxide powder from the oxidation reactor and a heated inert gas such as nitrogen (N₂). The induction heating elements and the heated inert gas heat the metal oxide powder such that the oxygen is liberated from the metal oxide powder and the reduced metal oxide powder is recycled back to the oxidation reactor. In the low-carbon hydrogen and syngas configurations, the reduction reactor is fed with oxidized metal oxide powder from the oxidation reactor and a heated hydrocarbon. The induction heating elements and the heated hydrocarbon heat the metal oxide powder such that the oxygen is liberated from the metal oxide powder and the metal oxide powder is recycled back to the oxidation reactor. Additionally, the metal oxide powder catalyzes a partial oxidation reaction within the reduction reactor between the hydrocarbon and the liberated oxygen to produce additional syngas. Furthermore, in some embodiments of the low-carbon hydrogen and syngas configurations, the additional syngas from the reduction reactor is further processed in a water-gas shift reaction to produce additional hydrogen.

Specifically, the reactions for the green hydrogen configuration are shown below in Equations 1 and 2:

$$Oxidation Reactor Reaction : 2 {H}_{2} O + Reduced MOP \to 2 {H}_{2} + Oxidized MOP \qquad Eqn . 1$$

$$Reduction Reactor Reaction : {N}_{2} + Oxidized MOP \to {N}_{2} + Reduced MOP + {O}_{2} \qquad Eqn . 2$$

The reactions for the low-carbon hydrogen configuration as shown below in Equations 3 and 4:

$$Oxidation Reactor Reaction : 2 {H}_{2} O + Reduced MOP \to 2 {H}_{2} + Oxidized MOP \qquad Eqn . 3$$

$$Reduction Reactor Reaction : 2 {CH}_{4} + Oxidized MOP \to 4 {H}_{2} + 2 CO + Reduced MOP \qquad Eqn . 4$$

The reactions for the green syngas configuration as shown below in Equations 5 and 6:

$$Oxidation Reactor Reaction : {H}_{2} O + {CO}_{2} + Reduced MOP \to {H}_{2} + Oxidized MOP + CO \qquad Eqn . 5$$

$$Reduction Reactor Reaction : {N}_{2} + Oxidized MOP \to {N}_{2} + Reduced MOP + {O}_{2} \qquad Eqn . 6$$

The reactions for the low-carbon syngas configuration as shown below in Equations 7 and 8:

$$Oxidation Reactor Reaction : {H}_{2} O + {CO}_{2} + Reduced MOP \to {H}_{2} + Oxidized MOP + CO \qquad Eqn . 7$$

$$Reduction Reactor Reaction : 2 {CH}_{4} + Oxidized MOP \to 4 {H}_{2} + 2 CO + Reduced MOP \qquad Eqn . 8$$

In some embodiments of the low-carbon hydrogen, green syngas, and low-carbon syngas configurations, the additional syngas from the reduction reactor is further processed in a water-gas shift reaction to produce additional hydrogen. The reaction for the additional water gas shift reaction is shown below in Equation 9:

$$Water Gas Shift Reaction : {H}_{2} O + CO ↔ {H}_{2} + {CO}_{2} \qquad Eqn . 9$$

In some embodiments, the systems and methods include a well-insulated, refractory-lined steel-enclosed fluidized or packed bed pressure vessel or reactor, in which process gases heated indirectly via concentrated solar radiation can be delivered to facilitate the desired thermochemical reactions in a fluidized bed configuration. The steel provides structural support for the reactor components and ensures that the system can contain expected pressures and establish sufficient leak integrity.

In some embodiments, the reactor components are lined with sufficient refractory insulation to mitigate conductive heat losses, ensure highly efficient heat-to-fuel conversion, and provide structural support for an induction coil. The induction coil delivers (e.g., via a susceptor) process heat to the reactor. In some embodiments, the steel enclosure may be water cooled.

The susceptor (or hard face) protects the refractory insulation from degradation via particle or powder bombardment. The bed of active material either reduces or oxidizes according to its extent of reaction and the relative reaction atmosphere.

In some embodiments, the method includes preheating gases, either an inert or reducing gas (e.g., N₂, Ar, CO, CH₄, etc.) or an oxidant gas (e.g., H₂O, CO₂, O₂, etc.). The preheated gases enter the reactor system. Inlet gases are then distributed through a grid (e.g., perforated plate, bubble cap tray, frit, etc.) to enforce a sufficient pressure drop (i.e., ΔPgrid≈0.3ΔPbed) and allow for particle fluidization. The fluidized bed region is configured such that, at process temperatures and pressures, the particles fluidize at a mass-specific flowrate in a range of approximately 1 mL min⁻¹ g⁻¹-100 mL min⁻¹ g⁻¹. Process heat is supplied via susceptor radiation. The fluidizing media will exchange heat via conduction, convection, and radiation.

Gases travel through the fluidized bed region, effect the desired reduction or oxidation transformation, and then continue through the upper plenum (or freeboard). In some embodiments, the upper plenum section is widened, having a width that is wider than the grid and fluidized bed sections of the reactor system such that the superficial gas velocity through the reactor decreases, thus reducing the amount of attrited particles (i.e., fines or powders) that are entrained in the flow.

Various kinds of reactors (e.g., a fluidized bed reactor, a packed bed reactor, a moving bed reactor, a transport reactor, etc.) may be used in the reactor system in the disclosed technology to facilitate thermochemical reactions.

In some embodiments, the systems and methods include other sustainable sources of heat, including heat derived from substantially renewable electricity via electromagnetic induction.

In some embodiments, gases exiting the upper plenum may be subjected to one cyclone or multiple cyclones-in-series to separate any remaining particles or fines entrained in the flow and insert the fines back into the fluidized bed region via a non-mechanical actuation (e.g., L-valve, loop seal, etc.).

In some embodiments, before interacting with downstream equipment, hot reactor effluent preheats the inlet gases via the exchange of heat.

In some embodiments, the reactor system may include a semi-batch configuration or a continuous configuration process. Other configurations are contemplated.

In a semi-batch configuration, reduction and oxidation gases are alternatively delivered to a bed of active material in the vessel for the thermochemical gas splitting technology. An inert or reducing gas is provided that removes oxygen from the material beds. One or more of water and carbon dioxide is delivered to the oxygen deficient or reduced material to produce hydrogen or syngas. Multiple reactors operate in concert to enable continuous throughput of the gaseous products (e.g., hydrogen or syngas) while the active material would remain situated within each dedicated fluidized bed reactor.

In a continuous configuration process, rather than alternating gas flow to a particular vessel, the active material is alternated and circulated between two or more vessels. In the continuous configuration process, there is a dedicated reduction reactor and a separate dedicated oxidation reactor, in which the active material circulates between. By separating the two-step process spatially, rather than temporally as done in the semi-batch configuration process, continuous throughput of gaseous product is enabled without the use of multiple reactors operating in parallel.

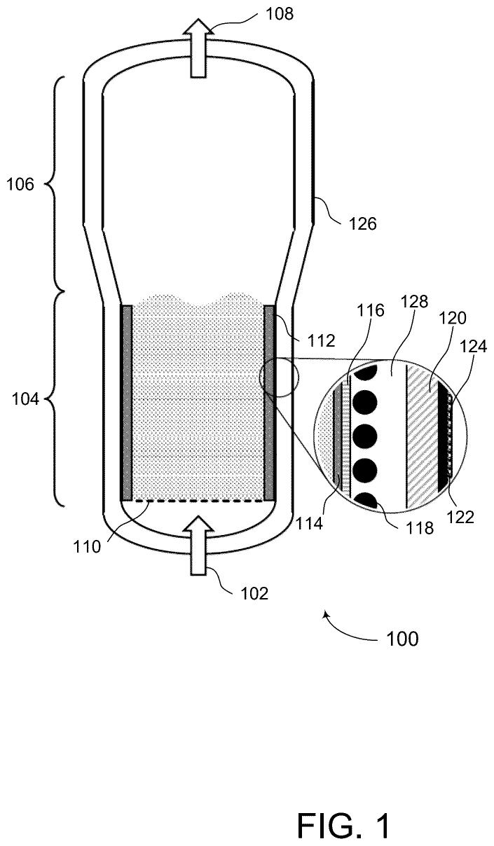

FIG. 1 is a schematic drawing of an embodiment of a reactor 100 for green hydrogen, low-carbon hydrogen, green syngas or low-carbon syngas production via thermochemical gas splitting in accordance with aspects of the present disclosure. As shown in FIG. 1, the reactor 100 includes a preheated gas inlet 102, a fluidized bed region 104, an upper plenum 106, and a gas outlet 108. The preheated gas inlet 102 may include a grid 110 for dispersing process gases within the fluidized bed region 104. Additionally, in some embodiments, the reactor 100 may include a liner system 112 positioned within the fluidized bed region 104 for heating the process gases within the fluidized bed region 104. In alternative embodiments, the liner system 112 may extend into the upper plenum 106 or may extend over the entire interior surface of the reactor 100. In some embodiments, the reactor 100 may be a steel vessel that is refractory-lined (e.g., alumina-silicate fire brick) to prevent the steel from getting too hot and contain the heat within the system.

As shown in FIG. 1, the liner system 112 includes a susceptor or hard face 114, insulation 116, induction coils 118 including supports (not shown) for the induction coils 118, refractory brick 120, a steel exterior 122, and a water cooling jacket 124 positioned on an exterior surface 126 of the steel exterior 122. The induction coils 118 (depicted as black circles in FIG. 1) are positioned in a gap 128 defined by the insulation 116 and the refractor brick 120. In alternative embodiments, the induction coils 118 may be embedded in the refractory brick 120. Additionally, in alternative embodiments, the induction coils 118 may also be coupled to the susceptor 114 to interact to provide heat to the fluidized bed region 104 that dissociates water and CO₂ to produce hydrogen and carbon monoxide or reduces the active material. The induction coils 118 may be coupled to a power source (not shown).

In each of the configurations of the disclosed technology, the induction coils 118 are configured to heat the fluidized bed region 104 of the reactor 100 (a reduction reactor in the illustrated embodiment) to liberate the oxygen from the metal oxide powder such that the metal oxide powder is recycled for use in an oxidation reactor. Specifically, in the green hydrogen and green syngas configurations, the reduction reactor 100 is fed with oxidized metal oxide powder from the oxidation reactor and a heated inert gas such as nitrogen (N₂). The induction coils 118 and the heated inert gas heat the metal oxide powder such that the oxygen is liberated from the metal oxide powder and the reduced metal oxide powder is recycled back to the oxidation reactor. In the low-carbon hydrogen and syngas configurations, the reduction reactor 100 is fed with oxidized metal oxide powder from the oxidation reactor and a heated hydrocarbon. The induction coils 118 and the heated hydrocarbon heat the metal oxide powder such that the oxygen is liberated from the metal oxide powder and the metal oxide powder is recycled back to the oxidation reactor. Additionally, the metal oxide powder catalyzes a partial oxidation reaction within the reduction reactor 100 between the hydrocarbon and the liberated oxygen to produce additional syngas.

In some embodiments, the reactor may include two sections (104 and 106), one section of larger width than the other, to change the gas velocity through the reactor and allow fluidization to be contained in the fluidized bed region 104 and allow particles to flow into a freeboard to be circulated back into the fluidized bed region 104. As shown in FIG. 1, the upper plenum area 106 is of greater width than the fluidized bed region 104.

In some embodiments, a grid or gas distribution plate 110 may be located at the pre-heated gas inlet to prevent the fluidized bed material from falling through the gas inlet. In FIG. 1, a grid is shown adjacent to the preheated gas inlet.

In some embodiments, the reactor system may include an internal or external cyclone and non-mechanical valves to circulate fines or powders while simultaneously isolating the conditions of each step (i.e., reduction vs. oxidation). In FIG. 1, an external cyclone is not shown. A gas outlet for the reactor system is shown, which leads to an external cyclone.

In some embodiments, the reactor system, the reactor, the cyclone, and other components have different configurations than the configuration shown in FIG. 1.

In some embodiments, the reactor is readily amenable to scale-up for large operations.

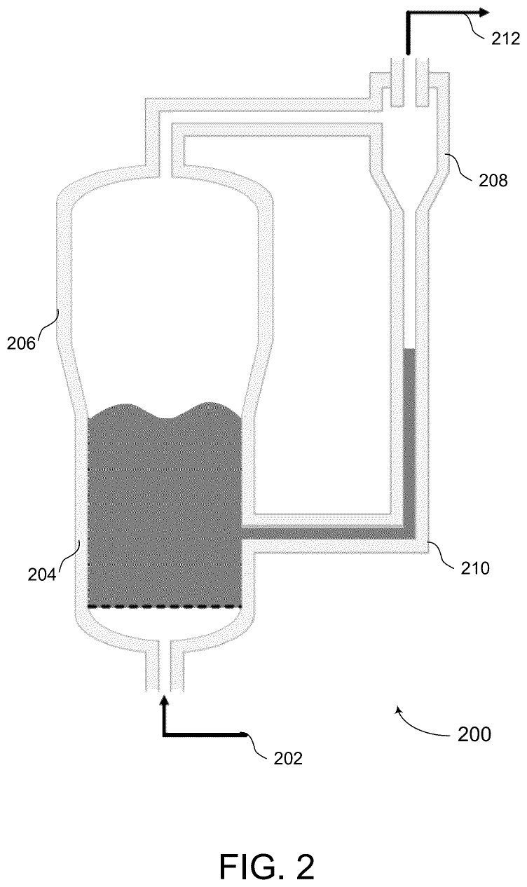

FIG. 2 is a schematic drawing of an embodiment of a reactor system 200 in accordance with aspects of the present disclosure. As shown in FIG. 2, the reactor system includes a preheated gas inlet 202, a fluidized bed region 204, an upper plenum 206, an external cyclone 208, L-valve 210, and a gas outlet 212. In FIG. 2, the gas outlet for the reactor system is configured as part of the external cyclone. Gases exiting the upper plenum 206 may be subjected to one cyclone 208 or multiple cyclones 208 in-series to separate any remaining particles or fines entrained in the flow and insert the fines back into the fluidized bed region via the L-valve 210 (a non-mechanical actuation).

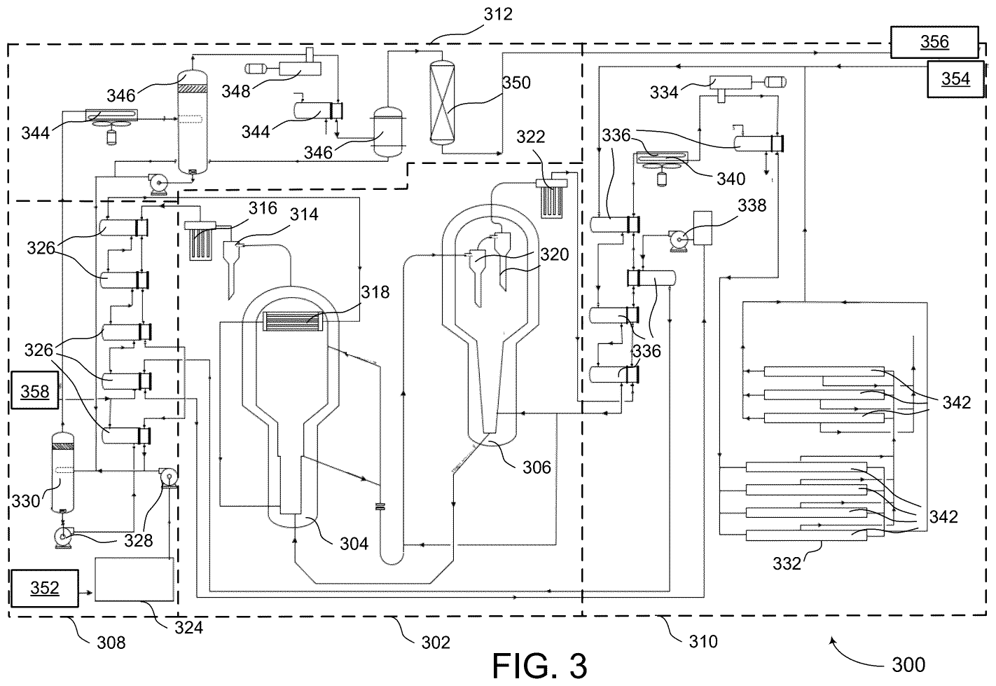

FIG. 3 is a flow diagram of an embodiment of a thermochemical system 300 configured for the green hydrogen and green syngas configurations in accordance with aspects of the present disclosure. As shown, the thermochemical system 300 includes a reactor system 302 including an oxidation reactor 304 and a reduction reactor 306. The thermochemical system 300 further includes a water/carbon dioxide supply system 308, a nitrogen supply system 310, and a hydrogen/syngas production system 312. In the illustrated embodiment, the water/carbon dioxide supply system 308 is configured to feed the oxidation reactor 304 with water in the green hydrogen configuration and water and carbon dioxide in the green syngas configuration. The nitrogen supply system 310 is configured to feed nitrogen to the reduction reactor 306. The hydrogen/syngas production system 312 is configured to receive hydrogen/syngas from the oxidation reactor 304, remove any residual water from the hydrogen/syngas, and deliver the produced hydrogen/syngas to other processes for additional processing.

Specifically, as shown in FIG. 3, the reactor system 302 further includes an oxidation reactor cyclone separator 314, an oxidation reactor filter 316, an internal oxidation/reduction reactor heat exchanger 318, two reduction reactor cyclone separators 320, and a reduction reactor filter 322. The produced hydrogen/syngas flows out of the top of the oxidation reactor 304 and into the oxidation reactor cyclone separator 314 to remove any entrained metal oxide powder. The oxidation reactor filter 316 also removes any entrained metal oxide powder. The internal oxidation/reduction reactor heat exchanger 318 is a ceramic heat exchanger configured to exchange heat between the produced hydrogen/syngas in the upper plenum 106 (shown in FIG. 1) of the oxidation reactor 304 and/or the reduction reactor 306 with water from the water/carbon dioxide supply system 308 to increase the efficiency of the thermochemical system 300. The two reduction reactor cyclone separators 320 are also configured to remove any entrained metal oxide powder in the process gasses within the reduction reactor 306 and the reduction reactor filter 322 also removes any entrained metal oxide powder.

As described above with respect to FIG. 1, the oxidation reactor 304 and/or the reduction reactor 306 may each include induction heating elements or coils 118 capable of heating material within the fluidized bed region 104 of the reactor 304 and/or 306 without disrupting the flow of process gases within the fluidized bed region 104 and within the short residence time of the process gases within the fluidized bed region 104. As such, the reactors 304 and/or 306 described herein are capable of delivering substantially renewable energy/heat to the fluidized bed region 104 without disrupting the flow of process gases and without disruptions to the power supply to the induction heating elements or coils 118 associated with at least some known substantially renewable sources of energy. Accordingly, the reactors 304 and/or 306 described herein are capable of producing hydrogen or syngas using substantially renewable energy sources, substantially reducing the environmental impact of the process of manufacturing hydrogen or syngas.

The water/carbon dioxide supply system 308 includes a deionized water treatment system 324 configured to treat raw water 352 for further processing, a plurality of water/carbon dioxide heat exchangers 326, a plurality of water/carbon dioxide pumps 328, and a water/carbon dioxide separator 330. The deionized water treatment system 324 treats raw water for use in the process and the water/carbon dioxide pumps 328 pump the treated water to the water/carbon dioxide separator 330. The water/carbon dioxide separator 330 separates the water from produced hydrogen/syngas. The produced hydrogen/syngas from the water/carbon dioxide separator 330 is sent to the hydrogen/syngas production system 312 for further processing. The water/carbon dioxide pumps 328 pump water from the water/carbon dioxide separator 330 to the plurality of water/carbon dioxide heat exchangers 326 to capture heat from the produced hydrogen/syngas.

Specifically, the produced hydrogen/syngas flows from the oxidation reactor 304 to the water/carbon dioxide heat exchangers 326 to exchange heat with the water from the water/carbon dioxide separator 330. The heated water from the water/carbon dioxide heat exchangers 326 then flows through the internal oxidation/reduction reactor heat exchanger 318 to capture additional heat and increase the efficiency of the thermochemical system 300. The heated water/carbon dioxide then flows into the fluidized bed region 104 (shown in FIG. 1) of the oxidation reactor 304.

In some embodiments, the thermochemical system 300 may be configured to produce hydrogen using the green hydrogen configuration described herein. In alternative embodiments, the thermochemical system 300 may be configured to produce green syngas using the green syngas configuration described herein. In the green syngas configuration, a flow of carbon dioxide 358 is introduced into the water sent to the water/carbon dioxide heat exchangers 326 such that the carbon dioxide is introduced into the feed for the oxidation reactor 304. The remainder of the process for the thermochemical system 300 remains the same as the green hydrogen configuration. The thermochemical system 300 may also be configured to have the flexibility to switch between the green hydrogen configuration and the green syngas configuration by simply introducing a flow carbon dioxide into the water sent to the water/carbon dioxide heat exchangers 326 when needed.

The nitrogen supply system 310 includes a nitrogen recovery system 332, a nitrogen system compressor 334, and a plurality of nitrogen heat exchangers 336. The plurality of nitrogen heat exchangers 336 may optionally include an additional cooling system 338. The nitrogen supply system 310 is configured to receive nitrogen and process the nitrogen for further processing in the reduction reactor 306. Specifically, as described above, the nitrogen is heated to liberate oxygen on the metal oxide powder in the reduction reactor and the plurality of nitrogen heat exchangers 336 are configured to heat the nitrogen to a suitable temperature. In the illustrated embodiment, the reduction reactor 306 produces a flow of nitrogen and oxygen and the plurality of nitrogen heat exchangers 336 are configured to exchange heat between the heated produced nitrogen and oxygen from the reduction reactor 306 with nitrogen from the nitrogen recovery system 332. Specifically, the produced nitrogen and oxygen is cooled by the incoming nitrogen 354 from the nitrogen recovery system 332 such that the produced nitrogen and oxygen is a suitable temperature to be processed by the nitrogen recovery system 332 and the incoming nitrogen 354 from the nitrogen recovery system 332 is heated by the produced nitrogen and oxygen such that the nitrogen is a suitable temperature for the reduction reactor 306.

The plurality of nitrogen heat exchangers 336 may include any type of heat exchangers that are configured to exchange heat between the incoming nitrogen 354 and the produced nitrogen and oxygen. Additionally, the plurality of nitrogen heat exchangers 336 may also include other heat exchange devices that are configured to control the temperature of the incoming nitrogen 354 and produced nitrogen and oxygen. For example, in the illustrated embodiment, the plurality of nitrogen heat exchangers 336 may further include an air cooler 340 configured to cool the produced nitrogen and oxygen prior to processing in the nitrogen recovery system 332. The plurality of nitrogen heat exchangers 336 may also include the additional cooling system 338 configured to provide additional cooling and/or heat exchange, as necessary. Specifically, in the illustrated embodiment, the additional cooling system 338 includes an oil cooling system that exchanges heat between the plurality of nitrogen heat exchangers 336 and the plurality of water/carbon dioxide heat exchangers 326 to increase the efficiency of the thermochemical system 300. In alternative embodiments, the plurality of nitrogen heat exchangers 336 and the plurality of water/carbon dioxide heat exchangers 326 may include any additional heat exchange devices that can be arranged in any configuration to increase the efficiency of the thermochemical system 300.

The nitrogen recovery system 332 is configured to separate the produced nitrogen and oxygen in order to recycle the nitrogen for use in the reduction reactor 306. Specifically, the nitrogen recovery system 332 includes a plurality of nitrogen recovery membranes 342 configured to separate the produced nitrogen from the produced oxygen. More specifically, the nitrogen system compressor 334 increases the pressure of the produced nitrogen and oxygen from the reduction reactor 306 to a suitable pressure for the plurality of nitrogen recovery membranes 342 to separate the produced nitrogen and oxygen. The separated oxygen is then vented to the atmosphere and the separated nitrogen is then sent to the plurality of nitrogen heat exchangers 336 for heating before being sent to the reduction reactor 306. In the illustrated embodiment, the plurality of nitrogen recovery membranes 342 are configured in both parallel and series configurations to optimize the recovery of nitrogen from the produced nitrogen and oxygen. In alternative embodiments, the plurality of nitrogen recovery membranes 342 may be arranged in any configuration that enables the nitrogen recovery system 332 to operate as described herein.

The hydrogen/syngas production system 312 is configured to receive produced hydrogen/syngas from the water/carbon dioxide separator 330 and process the produced hydrogen/syngas such that it is suitable for further processing in additional processes. The hydrogen/syngas production system 312 includes a plurality of hydrogen/syngas heat exchangers 344, a plurality of hydrogen/syngas knockout drums 346, a hydrogen/syngas compressor 348, and a hydrogen/syngas drier 350. The hydrogen/syngas heat exchangers 344 are configured to reduce the temperature of the produced hydrogen/syngas received from the water/carbon dioxide separator 330 and/or after compression in the hydrogen/syngas compressor 348. The hydrogen/syngas compressor 348 is configured to increase the pressure of the produced hydrogen/syngas to a pressure that is suitable for the hydrogen/syngas drier 350 to remove excess entrained moisture from the produced hydrogen/syngas. The plurality of hydrogen/syngas knockout drums 346 are configured to separate and remove excess entrained moisture from the produced hydrogen/syngas before and after compression by the hydrogen/syngas compressor 348.

The thermochemical system 300 is configured for the green hydrogen and green syngas configurations described above. Specifically, as described above, the water/carbon dioxide supply system 308 feeds the oxidation reactor 304 with water in the green hydrogen configuration and water and carbon dioxide in the green syngas configuration. The water/carbon dioxide supply system 308 also heats the water or water and carbon dioxide and cools the produced hydrogen/syngas to suitable temperatures using the plurality of water/carbon dioxide heat exchangers 326. The nitrogen supply system 310 feeds nitrogen to the reduction reactor 306 and heats the nitrogen to a suitable temperature prior to introduction to the reduction reactor 306. The nitrogen supply system 310 also cools the produced nitrogen and oxygen and separates the produced nitrogen from the produced oxygen for the separated nitrogen to be recycled back into the reduction reactor 306. The hydrogen/syngas production system 312 receives hydrogen/syngas from the oxidation reactor 304, removes any residual water from the hydrogen/syngas, and delivers the produced hydrogen/syngas 356 to other processes for additional processing. Additionally, the thermochemical system 300 has the flexibility to switch between producing hydrogen or syngas by introducing carbon dioxide into the system as described above. Accordingly, the thermochemical system 300 described herein is capable of producing hydrogen or syngas using substantially renewable energy sources, substantially reducing the environmental impact of the process of manufacturing hydrogen or syngas.

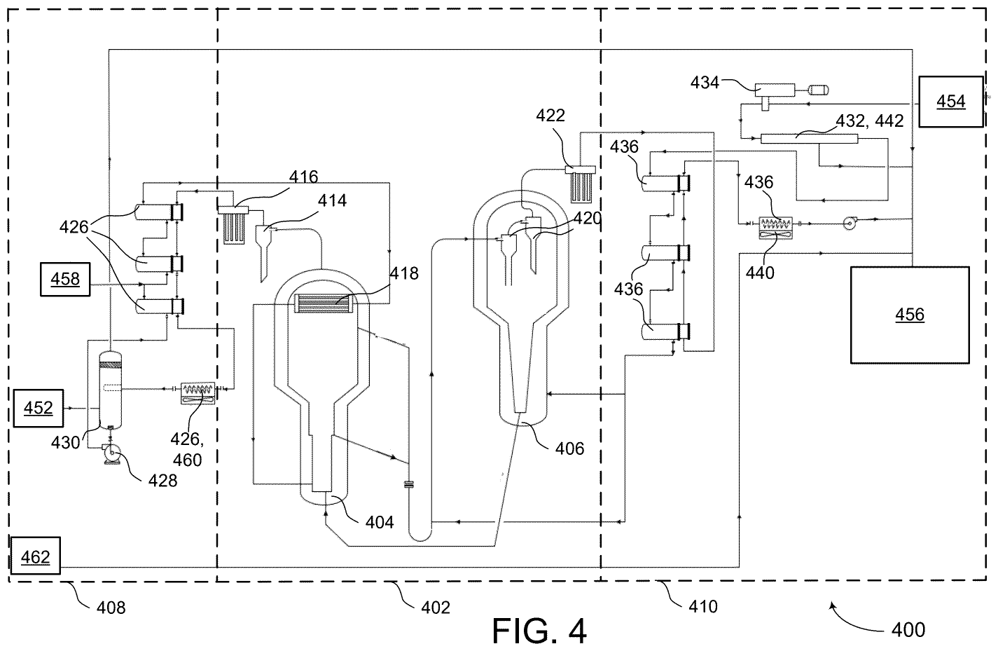

FIG. 4 is a flow diagram of an embodiment of a thermochemical system 400 configured for the low-carbon hydrogen and low-carbon syngas configurations in accordance with aspects of the present disclosure. As shown, the thermochemical system 400 includes a reactor system 402 including an oxidation reactor 404 and a reduction reactor 406. The thermochemical system 400 further includes a water/carbon dioxide supply system 408 and a hydrocarbon supply system 410. In the illustrated embodiment, the water/carbon dioxide supply system 408 is configured to feed the oxidation reactor 404 with water in the low-carbon hydrogen configuration and water and carbon dioxide in the low-carbon syngas configuration. The hydrocarbon supply system 410 is configured to feed hydrocarbons to the reduction reactor 406.

Specifically, as shown in FIG. 4, the reactor system 402 further includes an oxidation reactor cyclone separator 414, an oxidation reactor filter 416, an internal oxidation/reduction reactor heat exchanger 418, two reduction reactor cyclone separators 420, and a reduction reactor filter 422. The produced hydrogen/syngas flows out of the top of the oxidation reactor 404 and into the oxidation reactor cyclone separator 414 to remove any entrained metal oxide powder. The oxidation reactor filter 416 also removes any entrained metal oxide powder. The internal oxidation/reduction reactor heat exchanger 418 is a ceramic heat exchanger configured to exchange heat between the produced hydrogen/syngas in the upper plenum 106 (shown in FIG. 1) of the oxidation reactor 404 and/or the reduction reactor 406 with water from the water/carbon dioxide supply system 408 to increase the efficiency of the thermochemical system 400. The two reduction reactor cyclone separators 420 are also configured to remove any entrained metal oxide powder in the process gasses within the reduction reactor 406 and the reduction reactor filter 422 also removes any entrained metal oxide powder.

As described above with respect to FIG. 1, the oxidation reactor 404 and/or the reduction reactor 406 may each include induction heating elements or coils 118 capable of heating material within the fluidized bed region 104 of the reactor 404 and/or 406 without disrupting the flow of process gases within the fluidized bed region 104 and within the short residence time of the process gases within the fluidized bed region 104. As such, the reactors 404 and/or 406 described herein are capable of delivering substantially renewable energy/heat to the fluidized bed region 104 without disrupting the flow of process gases and without disruptions to the power supply to the induction heating elements or coils 118 associated with at least some known substantially renewable sources of energy. Accordingly, the reactors 404 and/or 406 described herein are capable of producing hydrogen or syngas using substantially renewable energy sources, substantially reducing the environmental impact of the process of manufacturing hydrogen or syngas.

The water/carbon dioxide supply system 408 includes a plurality of water/carbon dioxide heat exchangers 426, at least one water/carbon dioxide pump 428, and a water/carbon dioxide separator 430. The water/carbon dioxide supply system 408 may optionally also include a deionized water treatment system (not shown) and the deionized water treatment system treats raw water 452 for use in the process. The water/carbon dioxide separator 430 receives raw or treated water 452 and separates the water from produced hydrogen/syngas. The produced hydrogen/syngas 456 from the water/carbon dioxide separator 430 is sent to other processes/facilities for further processing. The water/carbon dioxide pump 428 pumps water from the water/carbon dioxide separator 430 to the plurality of water/carbon dioxide heat exchangers 426 to capture heat from the produced hydrogen/syngas. Specifically, the produced hydrogen/syngas flows from the oxidation reactor 404 to the water/carbon dioxide heat exchangers 426 to exchange heat with the water from the water/carbon dioxide separator 430. The heated water from the water/carbon dioxide heat exchangers 426 then flows through the internal oxidation/reduction reactor heat exchanger 418 to capture additional heat and increase the efficiency of the thermochemical system 400. The heated water/carbon dioxide then flows into the fluidized bed region 104 (shown in FIG. 1) of the oxidation reactor 404. The water/carbon dioxide heat exchangers 426 may include any type of heat exchangers that are configured to exchange heat between the incoming water/carbon dioxide and the produced hydrogen/syngas. Additionally, the water/carbon dioxide heat exchangers 426 may also include other heat exchange devices that are configured to control the temperature of the incoming water/carbon dioxide and the produced hydrogen/syngas. For example, in the illustrated embodiment, the water/carbon dioxide heat exchangers 426 may further include an air cooler 460 configured to cool the produced hydrogen/syngas prior to being sent to other processes and/or facilities.

In some embodiments, the thermochemical system 400 may be configured to produce low-carbon hydrogen using the low-carbon hydrogen configuration described herein. In alternative embodiments, the thermochemical system 400 may be configured to produce low-carbon syngas using the low-carbon syngas configuration described herein. In the low-carbon syngas configuration, a flow of carbon dioxide 458 is introduced into the water sent to the water/carbon dioxide heat exchangers 426 such that the carbon dioxide is introduced into the feed for the oxidation reactor 404. Additionally, a flow of carbon dioxide 462 may also be added to the produced hydrogen/syngas 456 for further processing in other facilities/processes. The remainder of the process for the thermochemical system 400 remains the same as the low-carbon hydrogen configuration. The thermochemical system 400 may also be configured to have the flexibility to switch between the low-carbon hydrogen configuration and the low-carbon syngas configuration by simply introducing a flow carbon dioxide into the water sent to the water/carbon dioxide heat exchangers 426 when needed.

The hydrocarbon supply system 410 includes a hydrogen recovery system 432, a hydrocarbon system compressor 434, and a plurality of hydrocarbon heat exchangers 436. The hydrocarbon supply system 410 is configured to receive hydrocarbons 454 and process the hydrocarbons 454 for further processing in the reduction reactor 406. Specifically, as described above, the hydrocarbons are heated to liberate oxygen on the metal oxide powder in the reduction reactor and to react to form syngas in both the low-carbon hydrogen and low-carbon syngas configurations. The plurality of hydrocarbon heat exchangers 436 are configured to heat the hydrocarbons to a suitable temperature. In the illustrated embodiment, the reduction reactor 406 produces a flow of syngas and the plurality of hydrocarbon heat exchangers 436 are configured to exchange heat between the heated produced syngas from the reduction reactor 406 with hydrocarbons from the hydrogen recovery system 432. Specifically, the produced syngas is cooled by the incoming hydrocarbons from the hydrogen recovery system 432 such that the produced syngas is a suitable temperature for further processing and the incoming hydrocarbons from the hydrogen recovery system 432 are heated by the produced syngas such that the hydrocarbons are a suitable temperature for the reduction reactor 406. The produced syngas is combined with the produced hydrogen/syngas from the water/carbon dioxide separator 430 for further processing in another facility or process.

The plurality of hydrocarbon heat exchangers 436 may include any type of heat exchangers that are configured to exchange heat between the incoming hydrocarbons and the produced syngas. Additionally, the plurality of hydrocarbon heat exchangers 436 may also include other heat exchange devices that are configured to control the temperature of the incoming hydrocarbons and the produced syngas. For example, in the illustrated embodiment, the plurality of hydrocarbon heat exchangers 436 may further include an air cooler 440 configured to cool the produced syngas prior to being sent for further processing. In alternative embodiments, the plurality of hydrocarbon heat exchangers 436 and the plurality of water/carbon dioxide heat exchangers 426 may include any additional heat exchange devices that can be arranged in any configuration to increase the efficiency of the thermochemical system 400.

The hydrogen recovery system 432 is configured to separate hydrogen within the incoming hydrocarbons 454 from actual hydrocarbons within the incoming hydrocarbons for use with syngas in other processes and/or facilities. Specifically, the hydrogen recovery system 432 includes a plurality of hydrogen recovery membranes 442 configured to separate hydrogen within the incoming hydrocarbons 454 from actual hydrocarbons within the incoming hydrocarbons. More specifically, the hydrocarbon system compressor 434 increases the pressure of the incoming hydrocarbons to a suitable pressure for the plurality of hydrogen recovery membranes 442 to separate hydrogen within the incoming hydrocarbons from actual hydrocarbons within the incoming hydrocarbons. The separated hydrogen is then added to the produced syngas and the separated hydrocarbons are then sent to the plurality of hydrocarbon heat exchangers 436 for heating before being sent to the reduction reactor 406. In the illustrated embodiment, the plurality of hydrogen recovery membranes 442 are configured in both parallel and series configurations to optimize the recovery of hydrogen. In alternative embodiments, the plurality of hydrogen recovery membranes 442 may be arranged in any configuration that enables the hydrogen recovery system 432 to operate as described herein.

The thermochemical system 400 is configured for the low-carbon hydrogen and low-carbon syngas configurations described above. Specifically, as described above, the water/carbon dioxide supply system 408 feeds the oxidation reactor 404 with water in the low-carbon hydrogen configuration and water and carbon dioxide in the low-carbon syngas configuration. The water/carbon dioxide supply system 408 also heats the water or water and carbon dioxide and cools the produced hydrogen/syngas to suitable temperatures using the plurality of water/carbon dioxide heat exchangers 426. In the low-carbon hydrogen configuration, the oxidation reactor 404 produces hydrogen and the reduction reactor 406 produces syngas, which are combined at the end of the process. In the low-carbon syngas configuration, the oxidation reactor 404 and the reduction reactor 406 both produce syngas, and the syngas streams are combined at the end of the process. The hydrocarbon supply system 410 feeds hydrocarbons to the reduction reactor 406 and heats the hydrocarbons to a suitable temperature prior to introduction to the reduction reactor 406. The hydrocarbon supply system 410 also cools the produced syngas. Additionally, the thermochemical system 400 has the flexibility to switch between producing hydrogen or syngas by introducing carbon dioxide into the system as described above. Accordingly, the thermochemical system 400 described herein is capable of producing hydrogen or syngas using substantially renewable energy sources, substantially reducing the environmental impact of the process of manufacturing hydrogen or syngas.

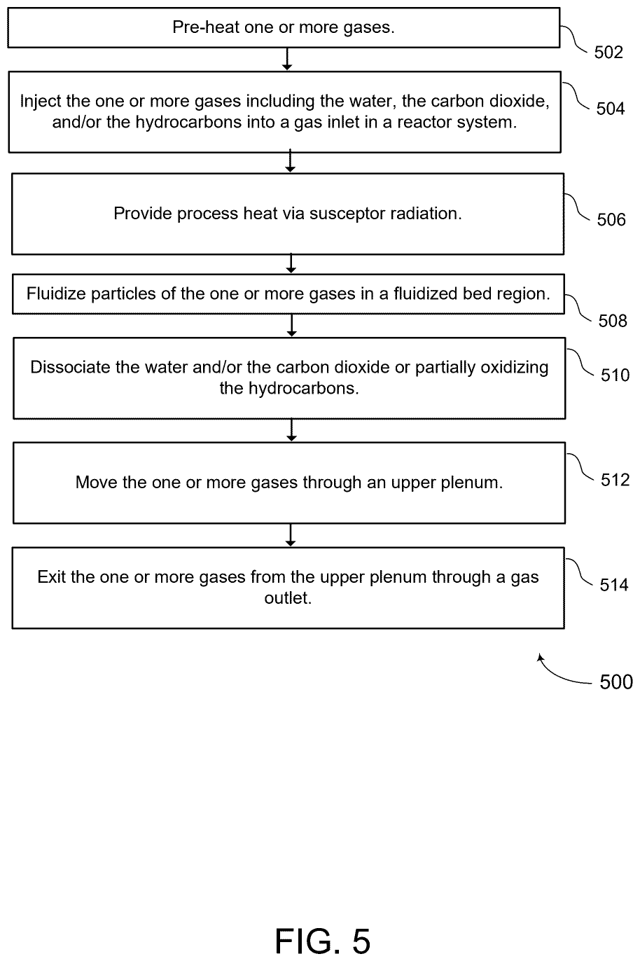

FIG. 5 is a flowchart of example operations for a method of producing hydrogen or syngas via a thermochemical gas splitting reactor system.

An operation 502 pre-heats one or more gases. The one or more gases may be an inert or reducing gas (e.g., N₂, Ar, CO, CH₄ etc.) or an oxidant gas (e.g., H₂O, CO₂, O₂, etc.). An operation 504 injects the one or more gases into a gas inlet in a reactor system. The reactor system components will be lined with refractory insulation to mitigate conductive heat losses and ensure highly efficient heat-to-fuel conversion.

The pre-heated gases are distributed through a grid (e.g., perforated plate, bubble cap tray, frit, etc.) to enforce a sufficient pressure drop and allow for particle fluidization. process heat is supplied in operation 506 primarily via susceptor radiation. The fluidizing media will exchange heat via conduction, convection, and radiation. Gases travel through the fluidized bed region, effect the desired reduction or oxidation transformation, and then continue through the upper plenum (or freeboard).

An operation 508 fluidizes particles via one or more gases in a fluidized bed region. The upper plenum section is widened such that the superficial gas velocity through the reactor decreases, thus reducing the amount of attrited particles (i.e., fines) that are entrained in the flow. An operation 510 disassociates the water and/or the carbon dioxide or partially oxidizes the hydrocarbons as described herein.

An operation 512 moves the one or more gases through an upper plenum and out 514 through a gas outlet in the reactor. In some embodiments, the gases exiting the upper plenum are subjected to either one cyclone or multiple cyclones-in-series to separate any remaining fines entrained in the flow and insert them back into the fluidized bed region via a non-mechanical actuation (i.e., L-valve, loop seal, etc.). Before interacting with downstream equipment, hot reactor effluent will preheat the inlet gases via the exchange of heat.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A method of producing hydrogen or syngas by thermochemical splitting of water, carbon dioxide, and/or hydrocarbons, the method comprising:
pre-heating one or more gases;
injecting the one or more gases including the water, the carbon dioxide, and/or the hydrocarbons into a gas inlet in a reactor system;
providing process heat via susceptor radiation;
fluidizing particles of the one or more gases in a fluidized bed region;
dissociating the water and/or the carbon dioxide or partially oxidizing the hydrocarbons;
moving the one or more gases through an upper plenum; and
exiting the one or more gases from the upper plenum through a gas outlet.

2. The method of claim 1, wherein the reactor system is made of steel.

3. The method of claim 1, wherein the reactor system refractory-lined.

4. The method of claim 1, wherein the reactor system is water cooled.

5. The method of claim 1, wherein the one or more gases are at least one of inert gas, reducing gas, and an oxidant gas.

6. The method of claim 5, wherein the inert or reducing gas is at least one of N₂, Ar, CO, CH₄, or C₂H₆.

7. The method of claim 5, wherein the oxidant gas is at least one of H₂O, CO₂, and O₂.

8. The method of claim 1, wherein the particles fluidize at a mass-specific flowrate in a range of approximately 1 mL min⁻¹ g⁻¹-100 mL min⁻¹ g⁻¹.

9. The method of claim 1, further comprising:
providing at least one cyclone to separate fines in the one or more gases; and
inserting the fines into the fluidized bed region via a non-mechanical actuation.

10. The method of claim 9, wherein the non-mechanical actuation includes a L-valve or a loop seal.

11. A thermochemical gas splitting reactor system comprising:
a reactor, the reactor lined with refractory brick, including:
a gas inlet to receive one or more pre-heated gases;
a fluidized bed region for receiving process heat and fluidizing particles of the one or more gases;
an induction coil embedded in the refractory brick coupled to a susceptor to conduct radiative heat to the fluidized bed region to dissociate water and carbon dioxide or partially oxidize a hydrocarbon to produce hydrogen and/or carbon monoxide;
an upper plenum to receive the one or more pre-heated gases; and
a gas outlet.

12. The reactor system of claim 11, wherein the reactor system is made of steel.

13. The reactor system of claim 11, further comprising a grid.

14. The reactor system of claim 11, further comprising a power source coupled to the induction coil.

15. The reactor system of claim 11, wherein the reactor system is water cooled.

16. The reactor system of claim 11, wherein the one or more gases are at least one of inert or reducing gas and an oxidant gas.

17. The reactor system of claim 16, wherein the inert or reducing gas is at least one of N₂, Ar, CO, CH4, or C2H6.

18. The reactor system of claim 16, wherein the oxidant gas is at least one of H₂O, CO₂, and O₂.

19. The reactor system of claim 1, wherein the particles fluidize at a mass-specific flowrate in a range of approximately 1 mL min⁻¹ g⁻¹-100 mL min⁻¹ g⁻¹.

20. The reactor system of claim 1, further comprising:
a cyclone to separate fines in the one or more gases.
